(19) United States
(12) Patent Application Publication
(10) Pub. No.: US 2016/0217335 A1
(43) Pub. Date: Jul. 28, 2016

(54) STIXEL ESTIMATION AND ROAD SCENE SEGMENTATION USING DEEP LEARNING

(71) Applicant: GM GLOBAL TECHNOLOGY OPERATIONS LLC, Detroit, MI (US)

(72) Inventors: DAN LEVI, KYRIAT ONO (IL); NOA GARNETT, TEL-AVIV (IL)

(73) Assignee: GM GLOBAL TECHNOLOGY OPERATIONS LLC, Detroit, MI (US)

(21) Appl. No.: 15/092,853

(22) Filed: Apr. 7, 2016

Related U.S. Application Data
(60) Provisional application No. 61/155,948, filed on Feb. 27, 2009.

(51) Int. Cl. G06K 9/00; G06K 9/66; B60R 11/04; G06T 7/00

(52) U.S. Cl. CPC G06K 9/00805; G06T 7/0081; G06K 9/66; B60R 11/04

(57) ABSTRACT

Methods and systems are provided for detecting an object in an image. In one embodiment, a method includes: receiving, by a processor, data from a single sensor, the data representing an image; dividing, by the processor, the image into vertical sub-images; processing, by the processor, the vertical sub-images based on deep learning models; and detecting, by the processor, an object based on the processing.

### CROSS REFERENCE TO RELATED APPLICATIONS

This application claims the benefit of U.S. Provisional Application No. 61/155,948 filed May 1, 2015 which is incorporated herein in its entirety.

### TECHNICAL FIELD

The technical field generally relates to object detection systems and methods, and more particularly relates to object detection systems and methods that detect objects based on deep learning.

### BACKGROUND

Various systems process data to detect objects in proximity to the system. For example, some vehicle systems detect objects in proximity to the vehicle and use the information about the object to alert the driver to the object and/or to control the vehicle. The vehicle systems detect the object based on sensors placed about the vehicle. For example, multiple cameras are placed in the rear, the side, and/or the front of the vehicle in order to detect objects. Images from the multiple cameras are used to detect the object based on stereo vision. Implementing multiple cameras in a vehicle or any system increases an overall cost.

Accordingly, it is desirable to provide methods and systems that detect objects in an image based on a single camera. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for detecting an object in an image. In one embodiment, a method includes: receiving, by a processor, data from a single sensor, the data representing an image; dividing, by the processor, the image into vertical sub-images; processing, by the processor, the vertical sub-images based on deep learning models; and detecting, by the processor, an object based on the processing.

In one embodiment, a system includes a non-transitory computer readable medium. The non-transitory computer readable medium includes a first computer module that receives, by a processor, data from a single sensor, the data representing an image. The non-transitory computer readable medium includes second computer module that divides, by the processor, the image into vertical sub-images. The non-transitory computer readable medium includes a third computer module that processes, by the processor, the vertical sub-images based on deep learning models, and that detects, by the processor, an object based on the processing.

### DESCRIPTION OF THE DRAWINGS

The exemplary embodiments will hereinafter be described in conjunction with the following drawing figures, wherein like numerals denote like elements, and wherein:

FIG. 1 is illustration of a vehicle that includes an object detection system in accordance with various embodiments;

FIG. 2 is a dataflow diagram illustrating an object detection module of the object detection system in accordance with various embodiments;

FIG. 3 is an illustration of a deep learning model in accordance with various embodiments;

FIGS. 4-6 are illustrations of image scenes in accordance with various embodiments; and

FIG. 7 is a flowchart illustrating an object detection method that may be performed by the object detection system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

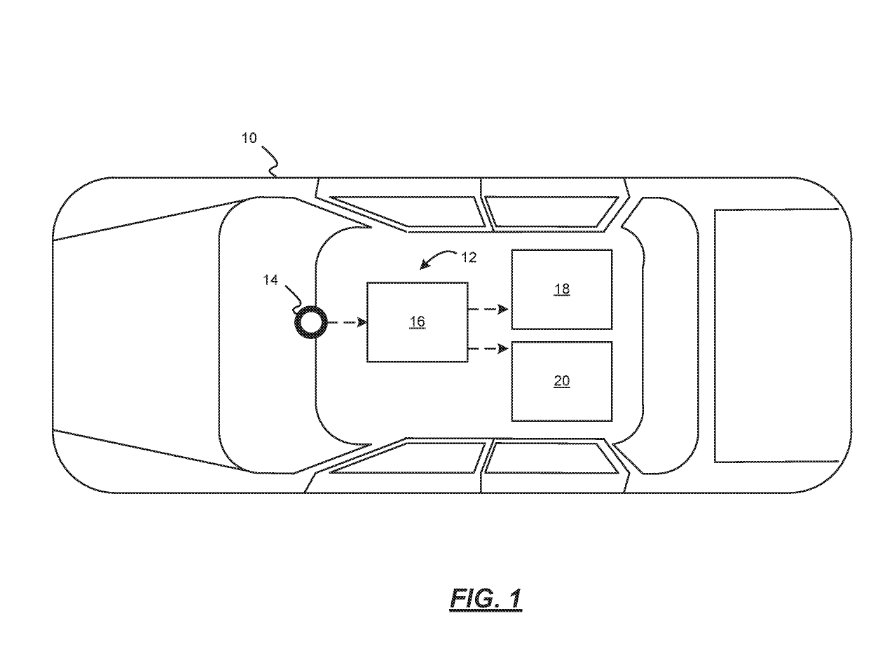

Referring now to FIG. 1, a vehicle 10 is shown to include an object detection system 12 in accordance with various embodiments. As can be appreciated, the object detection system 12 shown and described can be implemented in various systems including non-mobile platforms or mobile platforms such as, but not limited to, automobiles, trucks, buses, motorcycles, trains, marine vessels, aircraft, rotorcraft and the like. For exemplary purposes, the disclosure will be discussed in the context of the object detection system 12 being implemented in the vehicle 10. Although the figures shown herein depict an example with certain arrangements of elements, additional intervening elements, devices, features, or components may be present in an actual embodiments. It should also be understood that FIG. 1 is merely illustrative and may not be drawn to scale.

The object detection system 12 includes a single sensor 14 that is associated with an object detection module 16. As shown, the single sensor 14 senses observable conditions in proximity to the vehicle 10. The single sensor 14 can be any sensor that senses observable conditions in proximity to the vehicle 10 such as, but not limited to, a camera, a lidar, a radar, etc. For exemplary purposes, the disclosure is discussed in the context of the single sensor 14 being a camera that generates visual images of a scene outside of the vehicle 10.

The single sensor 14 can be located anywhere inside our outside of the vehicle 10, including but not limited to a front side of the vehicle 10, a left side of the vehicle 10, a right side of the vehicle 10, and a back side of the vehicle 10. As can be appreciated, multiple single sensors 14 can be implemented on the vehicle 10, one for each of or a combination of the front side of the vehicle 10, the left side of the vehicle 10, the right side of the vehicle 10, and the back side of the vehicle 10. For exemplary purposes, the disclosure will be discussed in the context of the vehicle 10 having only one single sensor 14.

The single sensor 14 senses an area associated with the vehicle 10 and generates sensor signals based thereon. In various embodiments, the sensor signals include image data. The object detection module 16 receives the signals, and processes the signals in order to detect an object. In various embodiments, the object detection module 16 selectively generates signals based on the detection of the object. The signals are received by a control module 18 and/or an alert module 20 to selectively control the vehicle 10 and/or to alert the driver to control the vehicle 10.

In various embodiments, the object detection module 16 detects the object based on an image processing method that processes the image data using deep learning models. The deep learning models can include, but are not limited to, neural networks such as convolutional networks, or other deep learning models such as deep belief networks. The deep learning models are pre-trained based on a plethora of sample image data.

In various embodiments, the object detection module 16 processes the image data using the deep learning models to obtain obstacle and other road elements within the image. The object detection module 16 makes use of the detected elements to determine for example, road segmentation, stixels within a scene, and/or objects within a scene.

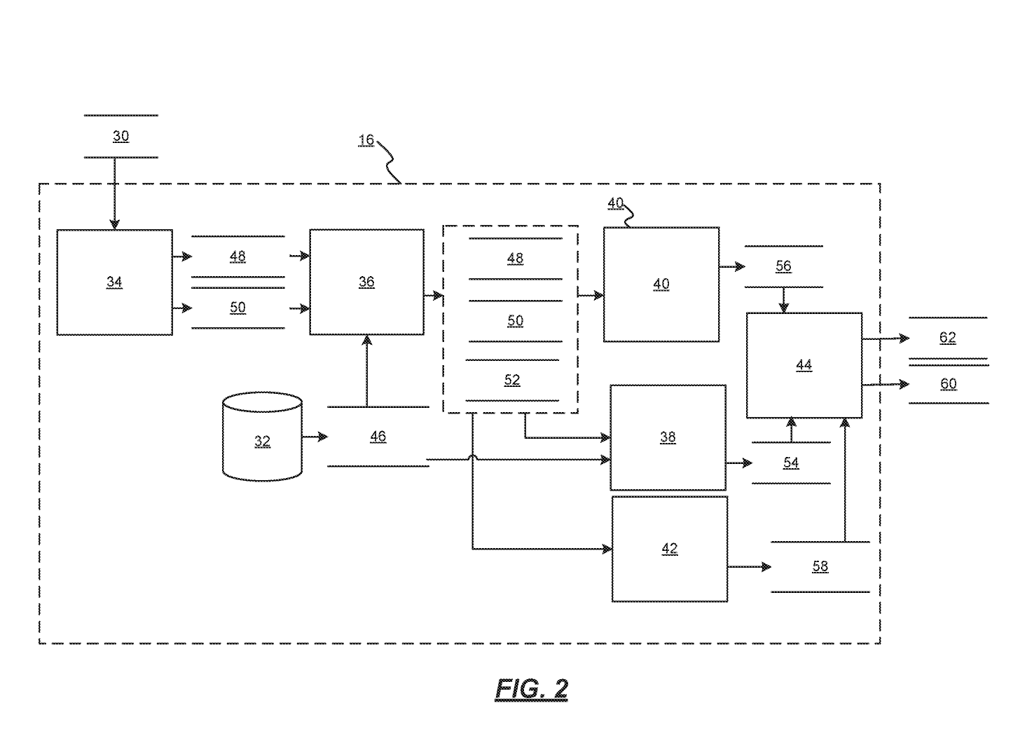

Referring now to FIG. 2, a dataflow diagram illustrates various embodiments of the object detection module 16 of the object detection system 12 (FIG. 1). The object detection module 16 processes image data 30 in accordance with various embodiments. As can be appreciated, various embodiments of the object detection module 16 according to the present disclosure may include any number of sub-modules. For example, the sub-modules shown in FIG. 2 may be combined and/or further partitioned to similarly process an image and to generate signals based on the processing. Inputs to the object detection module 16 may be received from the single sensor 14 of the vehicle 10 (FIG. 1), received from other control modules (not shown) of the vehicle 10 (FIG. 1), and/or determined by other sub-modules (not shown) of the object detection module 16. In various embodiments, the object detection module 16 includes a model datastore 32, an image processing module 34, a deep learning module 36, a stixel determination module 38, an object determination module 40, a road segmentation module 42, and/or a signal generator module 44.

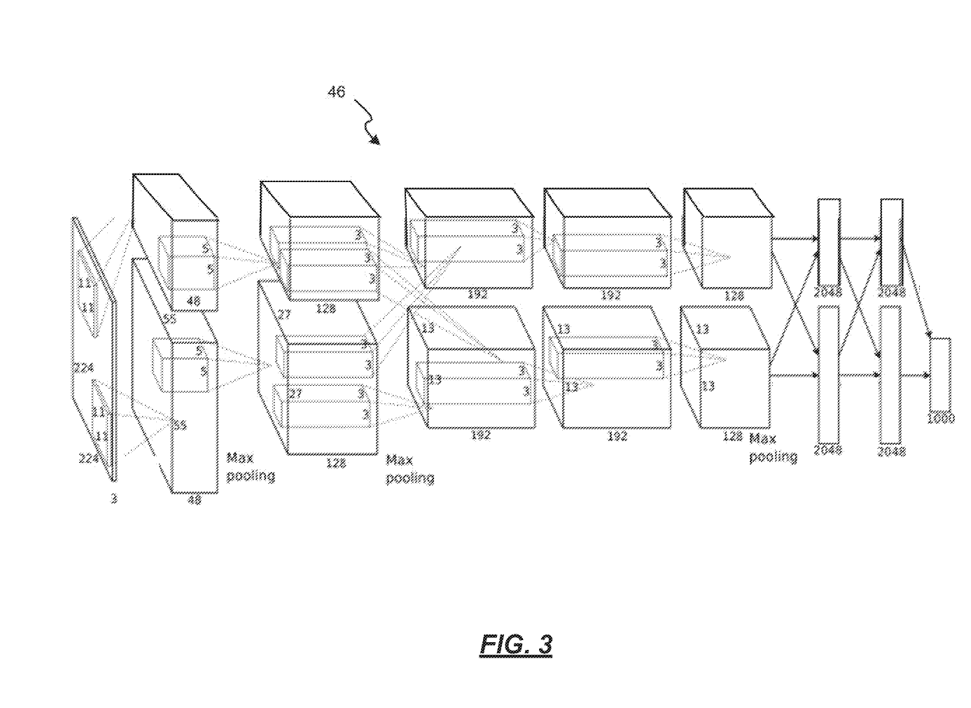

The model datastore 32 stores one or more deep learning models 46. For example, an exemplary deep learning model 46 is shown in FIG. 3. The exemplary deep learning model 46 is a convolutional network model. The convolutional network model includes multiple layers including a filtering layer and multiple pooling layers. The deep learning model 46 is trained based on a plethora of sample image data. In various embodiments, the sample data may represent certain scenes or types of objects that are associated with a vehicle.

With reference back to FIG. 2, the image processing module 34 receives as input the image data 30 representing an image captured from the single sensor 14 (FIG. 1). The image processing module 34 divides the image into a plurality of sub-images 48. For example, the plurality of sub-images 48 includes vertical sections or vertical stripes of the original image. As can be appreciated, the image processing module 34 can divide the image in various ways. For exemplary purposes, the disclosure will be discussed in the context of the image processing module 34 dividing the image into vertical sections or stripes.

The image processing module 34 further determines position data 50 of the sub-images 48 within the image. For example, the image processing module 34 assigns position data 50 to each sub-image 48 based on position of the sub-image within the original image. For example, the position assigned to the vertical sections corresponds to the X position along the X axis in the image.

The deep learning module 36 receives as input the sub-images 48, and the corresponding X position data 50. The deep learning module 36 processes each sub-image 48 using a deep learning model 46 stored in the model datastore 32. Based on the processing, the deep learning module 36 generates Y position data 52 indicating the boundary of road elements (bottom and/or top of each element) within each sub-image 48.

The stixel determination module 38 receives as input the plurality of sub-images 48, the X position data 50, and the Y position data 52. The stixel determination module 38 further processes each of the plurality of sub-images to determine a second Y position in the sub-image. The second Y position indicates an end point of the object in the sub-image. The stixel determination module 38 determines the second Y position in the sub-image based on a deep learning model 46 from the model datastore 32 and/or other image processing techniques.

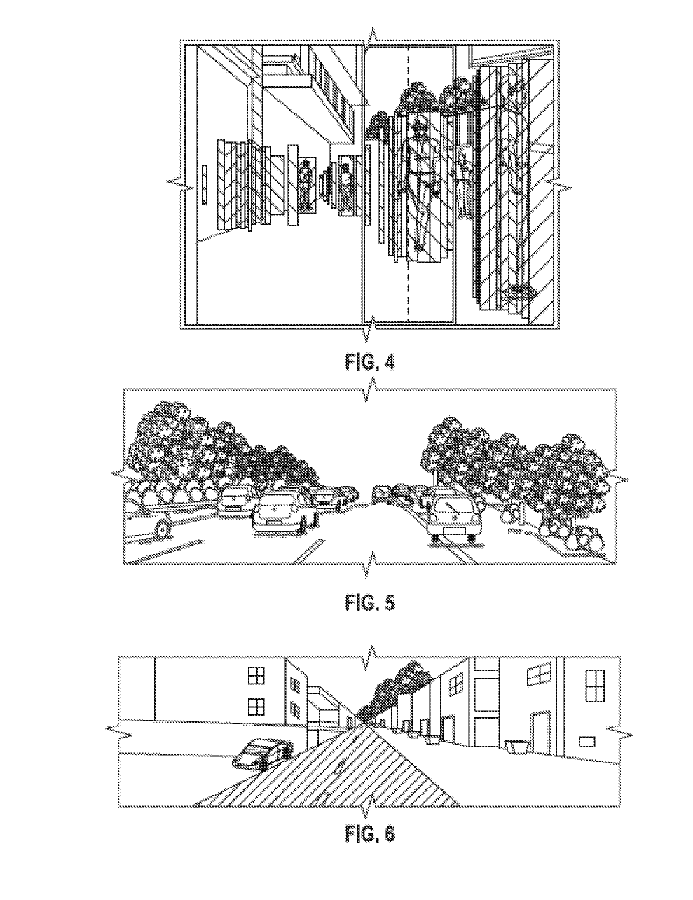

The stixel determination module 38 defines a stixel based on the X position, the first Y position, and the second Y position of a sub-image. For example, as shown in FIG. 4, the stixels begin at the determined ground truth (Y position) and end at the determined second Y position. If, for example, the first Y position and the second Y position are near the same, then a stixel may not be defined. The stixel determination module 38 generates stixel data 54 based on the defined stixels in the image.

With reference back to FIG. 2, the object determination module 40 receives as input the plurality of sub-images 48, the X position data 50, and the Y position data 52. The object determination module 40 determines the presence of an object based on the sub-image data 48 and the Y position data 52. For example, the object determination module 40 processes the captured image based on additional processing methods (e.g., optical flow estimation, or other methods) to determine if an object exists in the image above the determined Y position. As shown in FIG. 5, the object determination module 40 generates object data 56 indicating the X position and the Y position of the determined objects in the sub-images.

With reference back to FIG. 2, the road segmentation module 42 receives as input the plurality of sub-images 48, the X position data 50, and the Y position data 52. The road segmentation module 42 evaluates the sub-image data 48 and the Y position data 52 to determine an outline of a road in the scene. For example, as shown in FIG. 6, the road segmentation module 42 evaluates each row of the sub-image and defines the road segmentation based on the first and last X positions in the row that have an associated Y position. The road segmentation module 42 generates road segmentation data 58 based on the first and last X positions of all of the rows in the image.

With reference back to FIG. 2, the signal generator module 44 receives as input the stixel data 54, the object data 56, and/or the road segmentation data 58. The signal generator module 44 evaluates the stixel data 54, the object data 56, and/or the road segmentation data 58 and selectively generates an alert signal 60 and/or a control signal 62 based on the evaluation. For example, if an evaluation of the stixel data 54, and/or the object data 56 indicates that the object poses a threat, then an alert signal 60 and/or a control signal 62 is generated. In another example, if an evaluation of the road segmentation data 58 indicates that the vehicle 10 is veering off of the defined road, then an alert signal 60 and/or a control signal 62 is generated. As can be appreciated, the stixel data 54, the object data 56, and/or the road segmentation data 58 can be evaluated and signals generated based on other criteria as the described criteria are merely examples.

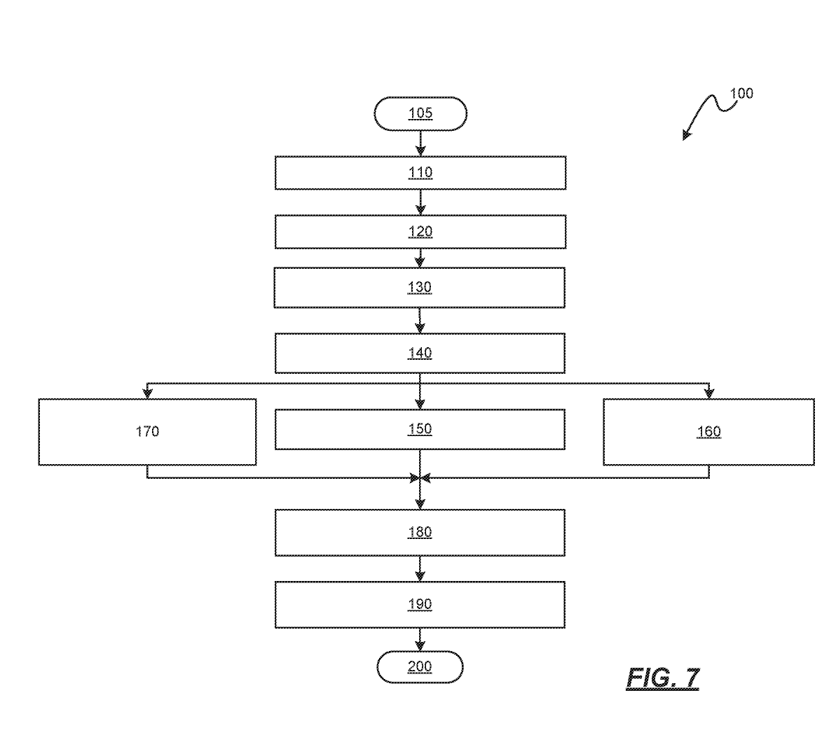

Referring now to FIG. 7, and with continued reference to FIGS. 1 and 2, a flowchart illustrates an object detection method 100 that may be performed by the object detection system 12 of FIGS. 1 and 2 in accordance with various embodiments. As can be appreciated in light of the disclosure, the order of operation within the method 100 is not limited to the sequential execution as illustrated in FIG. 7, but may be performed in one or more varying orders as applicable and in accordance with the present disclosure.

As can further be appreciated, the method of FIG. 7 may be scheduled to run at predetermined time intervals during operation of the vehicle 10 and/or may be scheduled to run based on predetermined events.

In one example, the method may begin at 105. The image data 30 is received at 110. From the image data 30, the sub-images 48 are determined at 120 and the X position data 50 of the sub-images 48 is determined at 130. The sub-images 48 are processed using a deep learning model 46 at 140 to determine the Y position data 52. The sub-images 48, the X position data 50, and the Y position data 52 is then processed at 150, 160, and/or 170 to determine at least one of stixel data 54, the object data 56, and/or the road segmentation data 58, respectively. The stixel data 54, the object data 56, and/or the road segmentation data 58, are evaluated at 180 and used to selectively generate the controls signals 62 and/or alert signals 60 at 190. Thereafter, the method may end at 200.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of detecting an object, comprising:
receiving, by a processor, data from a single sensor, the data representing an image;
dividing, by the processor, the image into vertical sub-images;
processing, by the processor, the vertical sub-images based on deep learning models; and
detecting, by the processor, an object based on the processing.

2. The method of claim 1, further comprising assigning position data to each of the vertical sub-images based on a location of the vertical sub-images in the image.

3. The method of claim 2, wherein the position data includes an X position along an X axis of the image.

4. The method of claim 1, wherein the processing the vertical sub-images further comprises processing the vertical sub-images using deep learning models to determine boundaries of road elements in the vertical sub-images.

5. The method of claim 4, wherein each boundary of road elements includes at least one of a bottom boundary, a top boundary, and a top and a bottom boundary.

6. The method of claim 4, wherein each boundary includes a Y position along a Y axis of the vertical sub-images.

7. The method of claim 4, further comprising processing data above the boundaries using an image processing technique to determine whether one or more objects exist above the boundaries in the in the vertical sub-images.

8. The method of claim 4, further comprising determining an outline of a road in the image based the boundaries and the vertical sub-images.

9. The method of claim 1, further comprising determining stixel data based on the vertical sub-images and the deep learning models.

10. The method of claim 9, wherein the determining the object is based on the stixel data.

11. A system for detecting an object, comprising:
a non-transitory computer readable medium comprising:
a first computer module that receives, by a processor, data from a single sensor, the data representing an image;
second computer module that divides, by the processor, the image into vertical sub-images; and
a third computer module that processes, by the processor, the vertical sub-images based on deep learning models, and that detects, by the processor, an object based on the processing.

12. The system of claim 11, wherein the first module assigns position data to each of the vertical sub-images based on a location of the vertical sub-images in the image.

13. The system of claim 12, wherein the position data includes an X position along an X axis of the image.

14. The system of claim 11, wherein the third module processes the vertical sub-images by processing the vertical sub-images using deep learning models to determine boundaries of road elements in the vertical sub-images.

15. The system of claim 14, wherein each boundary of road elements includes at least one of a bottom boundary, a top boundary, and a top and a bottom boundary.

16. The system of claim 14, wherein each boundary or road elements includes a Y position along a Y axis of the vertical sub-images.

17. The system of claim 14, further comprising a fourth module that processes data above the boundaries using an image processing technique to determine whether one or more objects exist above the boundaries in the vertical sub-images.

18. The system of claim 14, further comprising a fifth module that determines an outline of a road in the image based the boundaries and the vertical sub-images.

19. The system of claim 11, further comprising a sixth module that determines stixel data based on the vertical sub-images and the deep learning models.

20. The system of claim 19, wherein the sixth module determines the object based on the stixel data.
